(19) United States
(12) Patent Application Publication
(10) Pub. No.: US 2026/0135393 A1
(43) Pub. Date: May 14, 2026

(54) PRE-CHARGE OF DC LINK CAPACITOR BY BIDIRECTIONAL HVLV_DCDC CONVERTER AND 12 V BATTERY

(71) Applicant: Vitesco Technologies USA, LLC, Auburn Hills, MI (US)

(72) Inventors: Justin M. Hanson, Rochester Hills, MI (US); Albert Anzinger, Saal an der Donau (DE); Stefan Obermeier, Hausen (DE)

(73) Assignee: Vitesco Technologies USA, LLC, Auburn Hills, MI (US)

(21) Appl. No.: 18/831,420

(22) Filed: Jan. 18, 2025

Related U.S. Application Data
(60) Provisional application No. 63/714,332, filed on Oct. 31, 2024.

(51) Int. Cl. H02J 7/04; B60L 53/22; H02M 1/42; H02M 3/335

(52) U.S. Cl. CPC H02J 7/04; B60L 53/22; H02M 1/42; H02M 3/33569; H02J 2207/20

(57) ABSTRACT

A method for operating an on-board HV charging system configured to charge a traction battery of an electric vehicle, the on-board HV charging system having a Power Factor Correction (PFC) circuit to convert AC power from a mains supply into DC power for use in charging the traction battery, a bi-directional High Voltage to High Voltage (HVHV) DCDC converter electrically coupled to the traction battery; a DC link capacitor electrically coupled between the PFC circuit and the HVHV DCDC converter; and a bi-directional High Voltage to Low Voltage (HVLV) DCDC converter electrically coupled between the traction battery and a 12 V battery. The method controls the PFC circuit, HVHV DCDC converter, in a reverse mode, and the HVLV DCDC converter, in a reverse mode, to pre-charge the DC link capacitor using electrical power from the 12 V battery.

### FIELD

This invention relates to an HV system that integrates an on-board charger (OBC) and a bidirectional HVLV_DCDC converter for charging a traction battery of an electric vehicle (EV) and, more particularly, to a system and method that pre-charges a DC Link capacitor of the system by employing the bidirectional HVLV_DCDC converter and using power from a 12 V battery of the EV.

### BACKGROUND

With reference to FIG. 1, a conventional on-board charger (OBC), generally indicated at 10, handles the critical function of charging a high-voltage (HV) DC traction battery or battery pack 12 from an infrastructure power grid when an EV connects to a Level 1 or Level 2 wall outlet or electric vehicle supply equipment (EVSE) via AC connector 14 and suitable cable. An HV battery connector 13 and a HV contactors 15 is associated with the traction battery 12.

In order to avoid high inrush currents when the OBC 10 is connected to the AC grid, a pre-charge network, shown generally indicated at 16, is typically used to limit the current into the bulk storage DC Link Capacitor 18. The pre-charge network 16 includes a relay 20 and a high positive temperature coefficient (PTC) resistor 22. Parallel relays 24, 26 and the HV contactors can be closed when voltage of the DC Link Capacitor is near peak grid voltage. The OBC 10 also includes a conventional Power Factor Correction (PFC) circuit 28 to convert AC power to DC power. An AC filter 29 can be provided upstream of the PFC circuit 28. A bidirectional HVHV_DCDC converter 30, is provided for charging the HV battery 12. U.S. Pat. No. 10,351,004 discloses using the bidirectional HVHV_DCDC converter 30 to pre-charge the DC Link Capacitor 18 using power from the traction battery 12. In addition, bidirectional HVHV_DCDC converter 30 is used for vehicle to load, vehicle to home and vehicle to grid functions. In these vehicle to “x” functions, the bidirectional HVHV_DCDC converter needs to pre-charge the DC Link Capacitor 18 using the traction battery 12.

There is a need to provide a system and method that pre-charges the DC Link Capacitor 18 using a bidirectional HVLV_DCDC converter using power from a 12 V battery to avoid high inrush currents when the OBC 10 is connected to the AC grid.

### SUMMARY

An objective of the invention is to fulfill the need referred to above. In accordance with the principles of an embodiment, this objective is achieved by an on-board charger (OBC) for charging a traction battery of an electric vehicle. The OBC includes a Power Factor Correction (PFC) circuit configured to convert AC power from a mains supply into DC power for use in charging the traction battery; a bi-directional High Voltage to High Voltage (HVHV) DCDC converter electrically coupled to the traction battery; a DC link capacitor electrically coupled between the PFC circuit and the HVHV DC/DC converter; a bi-directional High Voltage to Low Voltage (HVLV) DCDC converter electrically coupled between the traction battery and a 12 V battery; and a processor circuit configured to control the PFC circuit, the HVHV DCDC converter, in a reverse mode, and the HVLV DCDC converter, in a reverse mode, to pre-charge the DC link capacitor using electrical power from the 12 V battery.

In accordance with another aspect of an embodiment, a method for operating an on-board charger (OBC) configured to charge a traction battery of an electric vehicle, the OBC having a Power Factor Correction (PFC) circuit to convert AC power from a mains supply into DC power for use in charging the traction battery, a bi-directional High Voltage to High Voltage (HVHV) DCDC converter electrically coupled to the traction battery; a DC link capacitor electrically coupled between the PFC circuit and the HVHV DCDC converter; and a bi-directional High Voltage to Low Voltage (HVLV) DCDC converter electrically coupled between the traction battery and a 12 V battery. The method controls the PFC circuit, HVHV DCDC converter, in a reverse mode, and the HVLV DCDC converter, in a reverse mode, to pre-charge the DC link capacitor using electrical power from the 12 V battery.

Other objectives, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a circuit diagram of a conventional OBC for an EV vehicle.

FIG. 2 is a circuit block diagram of an HV charging system for an EV vehicle provided in accordance with an embodiment.

FIG. 3 is a flowchart of a method of an embodiment.

### DETAILED DESCRIPTION OF AN EXEMPLARY EMBODIMENT

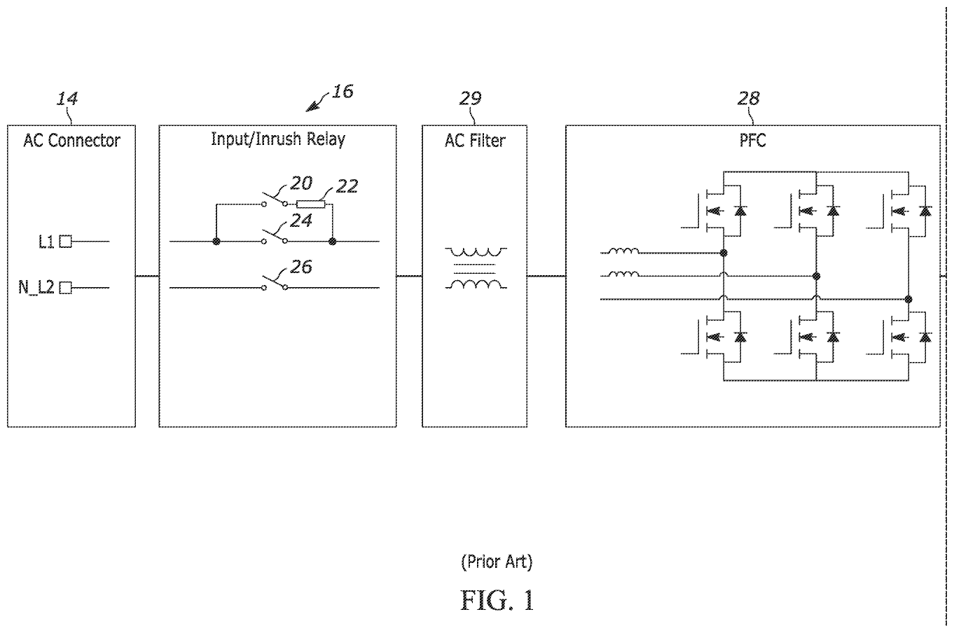

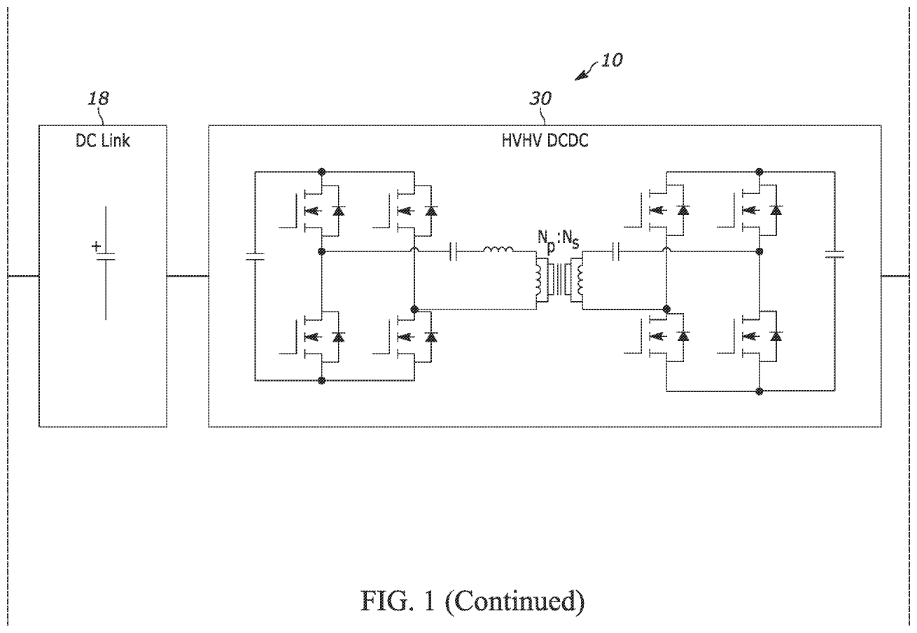

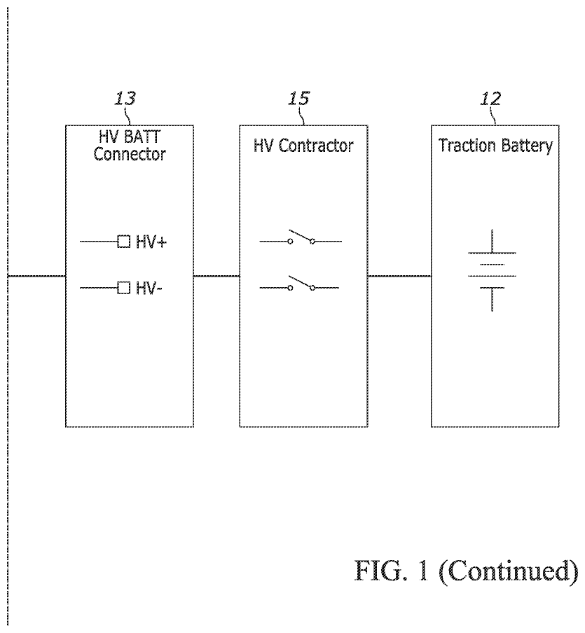

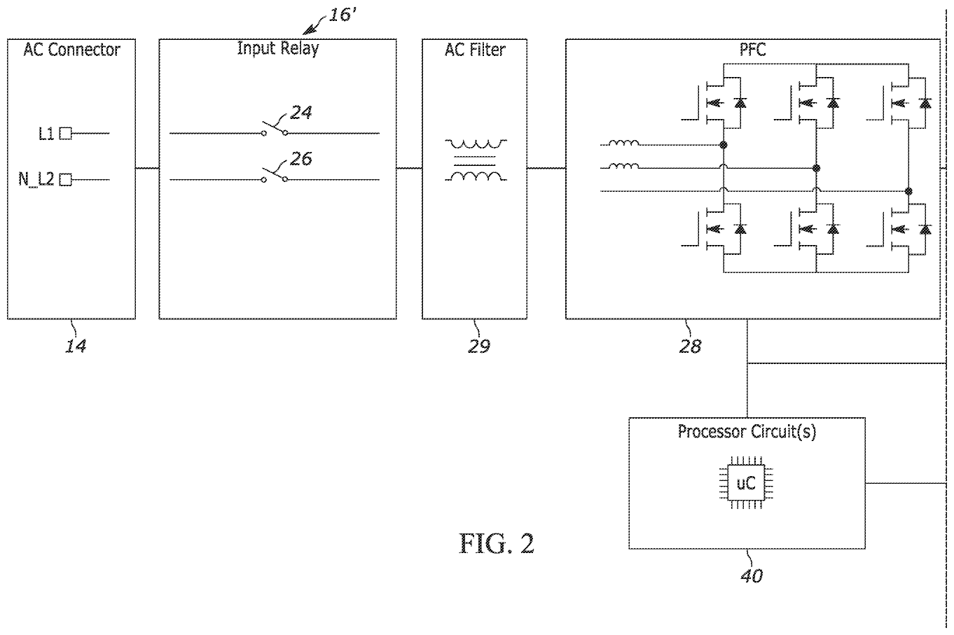

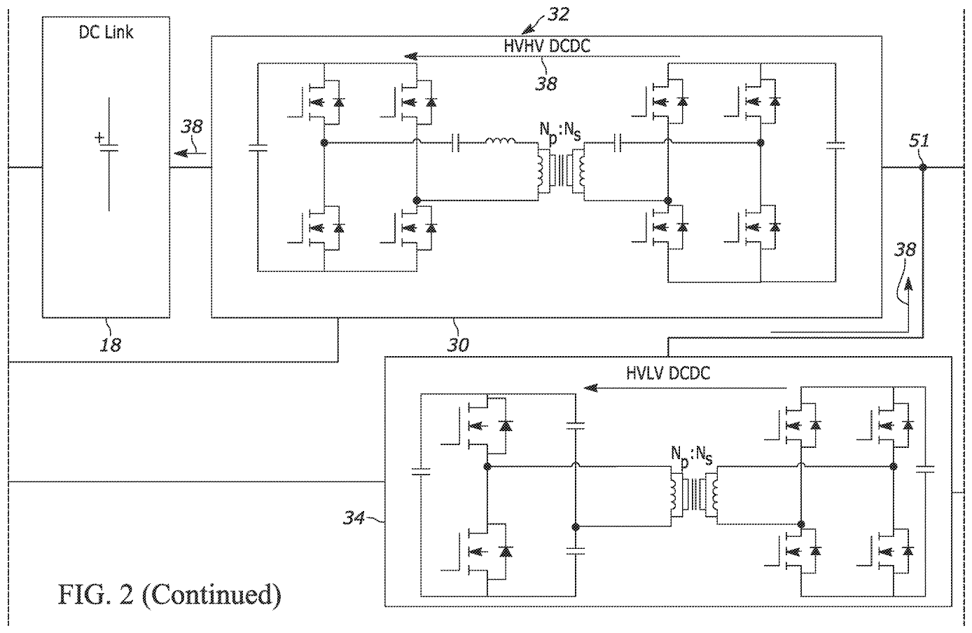

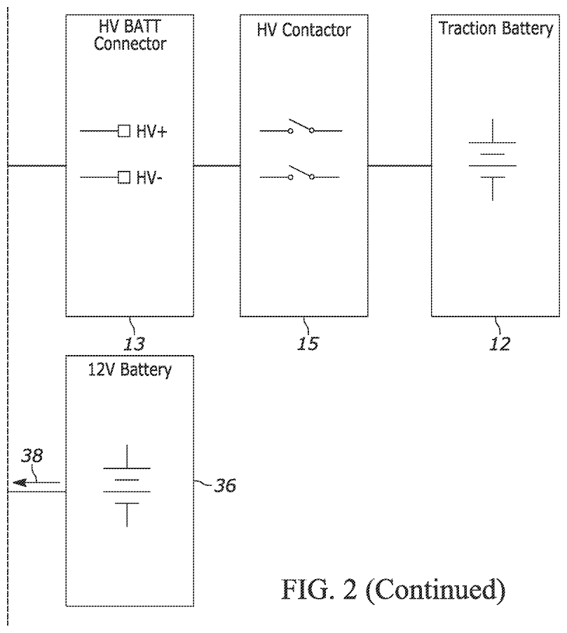

With reference to FIG. 2, circuit block diagram of an HV charging system (HV Box) for an EV vehicle is shown, generally indicated at 32 in accordance with an embodiment. The HV system 32 includes the components 14, 16′, 28, 18, 30, 13, 15 and 12 of the OBC of FIG. 1 and similarly handles the charging the high-voltage (HV DC) battery or battery pack 12 from an infrastructure power grid (mains supply) when an EV connects to a Level 1 or Level 2 wall outlet or electric vehicle supply equipment (EVSE) via the AC connector 14 and suitable cable.

As noted above, similar to that of FIG. 1, the HV system 32 of FIG. 2 includes the pre-charge network 16′, is typically used to limit the current into the bulk storage DC Link Capacitor 18. However, the pre-charge network 16′ includes only the parallel relays 24 and 26. The HV system 32 also includes a conventional Power Factor Correction (PFC) circuit 28 to convert the mains supply AC power to DC power for use in charging the traction battery 12. The bidirectional HVHV_DCDC converter 30 is provided, in a forward mode, for charging the HV traction battery 12. Parallel relays 24 and 26 and HV contactors 15 can be closed when voltage of the DC Link Capacitor is pre-charged to near peak grid voltage during the standard AC charging operation of the traction battery 12.

In accordance with the embodiment, the HV system 32 further integrates at least one high voltage to low voltage bidirectional HVLV_DCDC converter 34 electrically connected between the bidirectional HVHV_DCDC converter 30 and a 12 V battery 36 of the EV. Since the HVLV_DCDC converter 34 is bidirectional, it can also be considered a LVHV_DCDC converter when operated in the opposite or a reverse mode. At start up, the switches 24, 26 between the PFC 28 and AC connector 14 are disconnected to block inrush current flow when the AC voltage is connected and the DC Link Capacitor 18 is discharged or nearly discharged. Thus, at start-up, and in a pre-charge mode, the DC Link Capacitor 18 can be pre-charged directly by the low to high voltage DC converter (reverse mode of bidirectional HVLV_DCDC converter 34) with current passing through the bidirectional HVHV_DCDC converter 30 (in reverse mode), as indicated by current flow lines 38 in FIG. 2 and with power supplied only by the 12 V battery 36. Thus, the voltage of the DC Link Capacitor 18 is pre-charged from zero or substantially zero volts up to the minimum voltage that allows proper operation of the PFC 28 to charge the traction battery 12, in a charging mode, using the AC power from a mains supply.

After the pre-charge of the DC Link Capacitor 18, the PFC 28 boosts the voltage of the DC Link Capacitor 18 up to a desired voltage for normal operation of the OBC of the HV system 32. Alternatively, to reach the peak voltage level of the AC input, the DC Link Capacitor 18 can be charged by the HVLV_DCDC converter 34 and 12 V battery 36 together with the PFC circuit 28.

A processor circuit 40 is electrically connected to the HVLV_DCDC converter 34 and is configured to control switches of the converter 34. The processor circuit 40 is also electrically connected to the HVHV_DCDC converter 30 and is configured to control switches of the converter 30. Processor circuit 40 can also monitor the capacitor voltage of the DC Link Capacitor 18. Processor 40 is also configured to control the switches of the PFC 28 such as disabling the switches while the DC Link Capacitor 18 is being charged using electrical energy from the 12 V battery 34.

Since the low voltage 12 V battery 36 and the bidirectional HVLV-DCDC converter 34 pre-charge the DC Link Capacitor 18, the pre-charge relay 20 and PTC resistor 22 and any control circuitry associated there-with are removed from pre-charge network 16′. This will reduce cost and save space in the design when bidirectional functionality is required.

Typically, the HVHV_DCDC converter 30 can be used for vehicle to load, vehicle to home and vehicle to grid functions. In these vehicle to “x” functions, the bidirectional HVHV_DCDC converter 30 can pre-charge the DC Link Capacitor 18 using power from the traction battery 12. However in accordance with the embodiment, instead of using the HVHV_DCDC converter 30, the bidirectional HVLV_DCDC converter 34 can be used for vehicle to load, vehicle to home and vehicle to grid functions. In these vehicle to “x” functions, the bidirectional HVLV_DCDC converter 34 can pre-charge the DC Link Capacitor 18 using power from the 12 V battery 36.

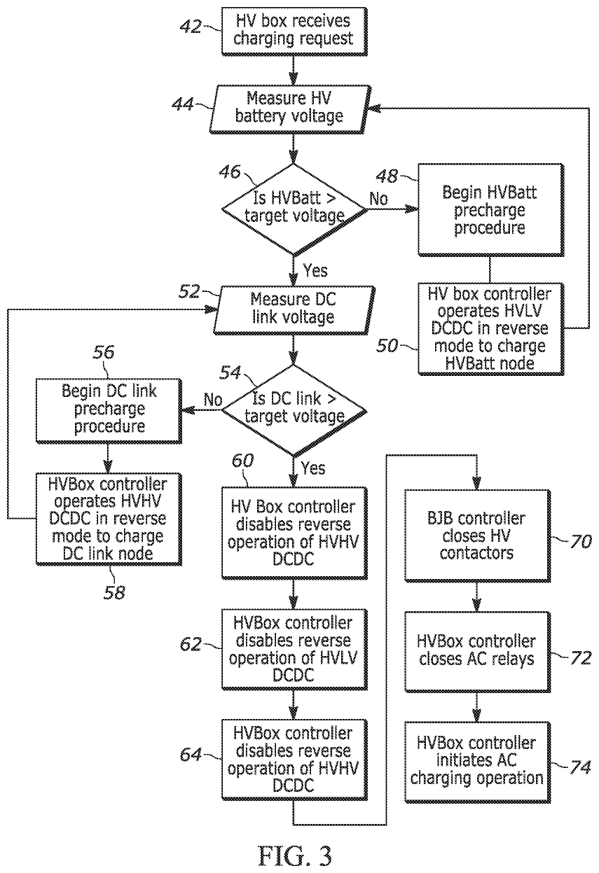

FIG. 3 is a flowchart of a process of the embodiment. In step 42, the HV Box 32 receives a charging request. In step 44, the HV battery 12 voltage is measured. In step 46, the processor circuit 40 (or other sensor) determines if the voltage of the HV battery 12 is greater than a target voltage and, if not, the HV pre-charge procedure is initiated in step 48, and in step 50, the processor circuit 40 controls the HVLV_DCDC converter 34 in reverse mode to pre-charge the HV battery node 51 (FIG. 2) that is disposed between the HVHV_DCDC converter 30 and traction battery 12. Thus, node 51 is pre-charged and it will later be connected to the HV battery 12 when the HV contactors 15 close. Pre-charging of node 51 prevents arcing of the HV contactors 15. After step 50, the process returns to step 44. If the voltage of the HV battery 12 is not greater than the target voltage, in step 52, the processor circuit (or other sensor) measures the voltage of the DC Link Capacitor 18. In step 54, if it is determined that the voltage of the DC Link Capacitor 18 is greater than a target voltage and if not, in step 56, the DC link pre-charge procedure is initiated. In step 58, the system 32 processor circuit 40 operates the HVHV_DCDC 30 in reverse mode to charge the DC Link Capacitor 18 using power from the 12V battery 36, prior to the HV contactors 15 and the AC relays 24, 26 close. After step 58, the process returns to step 52. In step 54, if it is determined that the voltage of the DC Link Capacitor 18 is greater than the target voltage, in steps 60, 62, the processor circuit 40 disables the reverse operation of the HVHV_DCDC converter 30 and the HVLV_DCDC converter 34, respectively. In step 70, a controller closes the HV contactors 15 and in step 72, the processor circuit 40 closes the relays 24 and 26. Finally, in step 74, the processor circuit 40 initiates the standard AC charging operation.

The operations and algorithms described herein can be implemented as executable code within the processor circuit 40 as described, or stored on a standalone computer or machine readable non-transitory tangible storage medium that are completed based on execution of the code by a processor circuit implemented using one or more integrated circuits. Example implementations of the disclosed circuits include hardware logic that is implemented in a logic array such as a programmable logic array (PLA), a field programmable gate array (FPGA), or by mask programming of integrated circuits such as an application-specific integrated circuit (ASIC). Any of these circuits also can be implemented using a software-based executable resource that is executed by a corresponding internal processor circuit such as a micro-processor circuit and implemented using one or more integrated circuits, where execution of executable code stored in an internal memory circuit causes the integrated circuit(s) implementing the processor circuit to store application state variables in processor memory, creating an executable application resource (e.g., an application instance) that performs the operations of the circuit as described herein. Hence, use of the term “circuit” in this specification refers to both a hardware-based circuit implemented using one or more integrated circuits and that includes logic for performing the described operations, or a software-based circuit that includes a processor circuit (implemented using one or more integrated circuits), the processor circuit including a reserved portion of processor memory for storage of application state data and application variables that are modified by execution of the executable code by a processor circuit. A memory circuit of the processor circuits 38, 40 can be implemented, for example, using a non-volatile memory such as a programmable read only memory (PROM) or an EPROM, and/or a volatile memory such as a DRAM, etc.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

What is claimed is:

1. An on-board HV charging system for charging a traction battery of an electric vehicle, comprising:
a Power Factor Correction (PFC) circuit configured to convert AC power from a mains supply into DC power for use in charging the traction battery;
a bi-directional High Voltage to High Voltage (HVHV) DCDC converter electrically coupled to the traction battery;
a DC link capacitor electrically coupled between the PFC circuit and the HVHV DC/DC converter;
a bi-directional High Voltage to Low Voltage (HVLV) DCDC converter electrically coupled between the HVHV DC/DC converter and a 12 V battery;
a processor circuit configured to control the PFC circuit, the HVHV DCDC converter, in a reverse mode, and the HVLV DCDC converter, in a reverse mode, to pre-charge the DC link capacitor using electrical power from the 12 V battery.

2. The on-board HV charging system of claim 1, wherein the processor circuit is configured to disable the PFC circuit while the DC link capacitor is being charged using electrical power from the 12 V battery.

3. The on-board HV charging system of claim 1, wherein the processor circuit is configured to control the PFC circuit and the HVHV DCDC converter, in a forward mode, to charge the traction battery using the AC power from a mains supply.

4. The on-board HV charging system of claim 3, wherein the processor circuit is configured to control the HVHV DCDC converter and the HVLV DCDC converter in reverse modes to pre-charge the DC link capacitor, using electrical power from the 12 V battery, from substantially zero volts to a minimum voltage that allows proper operation of the PFC circuit to charge the traction battery using the AC power from the mains supply.

5. The on-board HV charging system of claim 1, wherein the processor circuit is configured to pre-charge the DC link capacitor using the HVLV DCDC converter and 12 V battery together with the PFC circuit.

6. A method for operating an on-board HV charging system configured to charge a traction battery of an electric vehicle, the HV charging system having a Power Factor Correction (PFC) circuit to convert AC power from a mains supply into DC power for use in charging the traction battery, a bi-directional High Voltage to High Voltage (HVHV) DCDC converter electrically coupled to the traction battery; a DC link capacitor electrically coupled between the PFC circuit and the HVHV DCDC converter; and a bi-directional High Voltage to Low Voltage (HVLV) DCDC converter electrically coupled between the traction battery and a 12 V battery; the method comprising:
controlling, in a pre-charge mode, the PFC circuit, HVHV DCDC converter, in a reverse mode, and the HVLV DCDC converter, in a reverse mode, to pre-charge the DC link capacitor using electrical power from the 12 V battery.

7. The method of claim 6, further comprising:
controlling, in a charging mode, the PFC circuit and the HVHV DCDC converter, in a forward mode, to charge the traction battery using AC power from the mains supply.

8. The method of claim 6, wherein the controlling step includes disabling the PFC circuit while the DC link capacitor is being charged using electrical energy from the 12 V battery.

9. The method of claim 7, wherein, in the pre-charge mode, the controlling step pre-charges the DC link capacitor, using electrical power from the 12 V battery, from substantially zero volts to a minimum voltage that allows proper operation of the PFC circuit to charge the traction battery using the AC power from the mains supply.

10. The method of claim 6, wherein the controlling step pre-charges the DC link capacitor using the HVLV DCDC converter and 12 V battery together with the PFC circuit.

11. The method of claim 6, wherein the controlling step occurs during a vehicle to load mode, vehicle to home mode or vehicle to grid function mode of operation.

12. The method of claim 7, wherein the pre-charge mode controlling step occurs prior to the charging mode controlling step.
